(19) United States
(12) Patent Application Publication
(10) Pub. No.: US 2006/0288596 A1
(43) Pub. Date: Dec. 28, 2006

(54) Speed-T-square cutting device

(76) Inventor: Jeffrey A. Markert, Gainesville, GA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 11/169,177

(22) Filed: Jun. 27, 2005

(51) Int. Cl. B43L 13/00

(52) U.S. Cl. 33/32.3

(57) ABSTRACT

An apparatus for scoring drywall in both the horizontal and vertical directions with minimal repositioning of the apparatus between cuts; comprising a conventional T-square with a slide track rigidly affixed to the vertical portion and a body, slideably affixed to the track, containing two retractable blades positioned for cutting horizontally or vertically, the blades being retracted and extended by rotation of the blade knob located on an upper surface of the block portion.

### BACKGROUND OF THE INVENTION

1. Field of the Invention

This invention relates generally to an apparatus and method for scoring a surface and preferably drywall in both the horizontal and vertical directions, and specifically to an apparatus and method for safely and accurately scoring drywall quickly in both the horizontal and vertical directions, comprising a T-square device with a slide track and sliding body with retractable blades attached thereto.

2. Background

Drywall, often referred to as gypsum wall or plasterboard, is reinforced gypsum plaster sandwiched between two layers of strong paper. Drywall is manufactured and transported in large sheets. During construction, workers need to cut the drywall to the appropriate size. This is usually done through a process called scoring, where the outer paper layer is cut using a sharp blade. The worker is then able to make a clean break in the drywall along the scored line.

Many techniques have evolved to cut the drywall in a precise fashion. Edges must be perfectly straight, and comers must be made at right angles. To accomplish this, workers often use T-square devices, measuring tape, rulers, and other devices to ensure the utility knife cuts precisely.

Some scoring devices have been developed for use in conjunction with T-squares. These devices, however, only allow for cutting in one direction, and the entire device must be repositioned for multiple cuts in multiple directions. Additionally, these devices contain continuously exposed blades. These exposed blades can dangerous to the user in two different ways. First, the free blade can cut the user during scoring, repositioning, and general use of the device. Secondly, their exposed nature increases the possibility that the blade will break off.

Accordingly, a need exists for a cutting device that works in both the vertical and horizontal direction and is safe to operate.

### SUMMARY OF THE INVENTION

The object of the present invention comprises providing a cutting device that can operate safely in both the vertical and the horizontal direction.

The present invention is a drywall scoring apparatus having a T-square portion comprised of two perpendicularly arranged legs connected with a plurality of fasteners. The main extension portion has an upper and a lower surface. A slide track is affixed to one leg of the T-square and a body slideably affixed to the slide track. On the upper surface of the box portion is a blade selector knob, which moves a blade between a retracted and an extended position.

These and other objects of the present invention will become apparent to one skilled in the art upon presentation of the accompanying drawings, description, and claims.

### BRIEF DESCRIPTION OF THE DRAWINGS

FIG. 1a is a perspective view of a modified T-square of the present invention.

FIG. 1b is a side view of the T-square taken along the line 1b shown in FIG. 1a.

FIG. 2 is a bottom view of a body of the present invention.

FIG. 3 is a partial top view of the body.

FIG. 4 is a side view of the body.

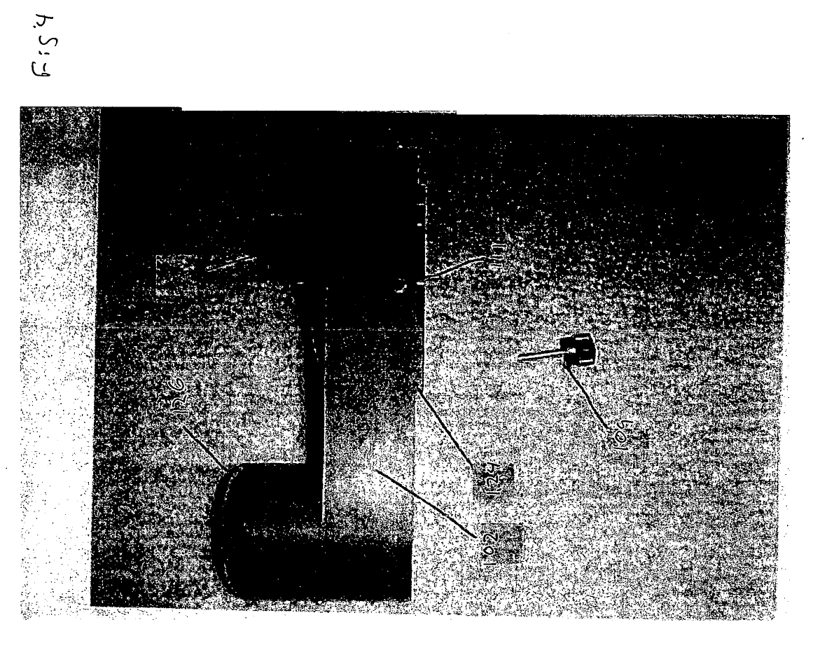

FIG. 5 is a top view of the body.

FIG. 6 is a side view of blade holder sections of the body.

FIG. 7 is a perspective view of the blade holder.

FIG. 8 is a top view of a horizontal and a vertical bar of the body.

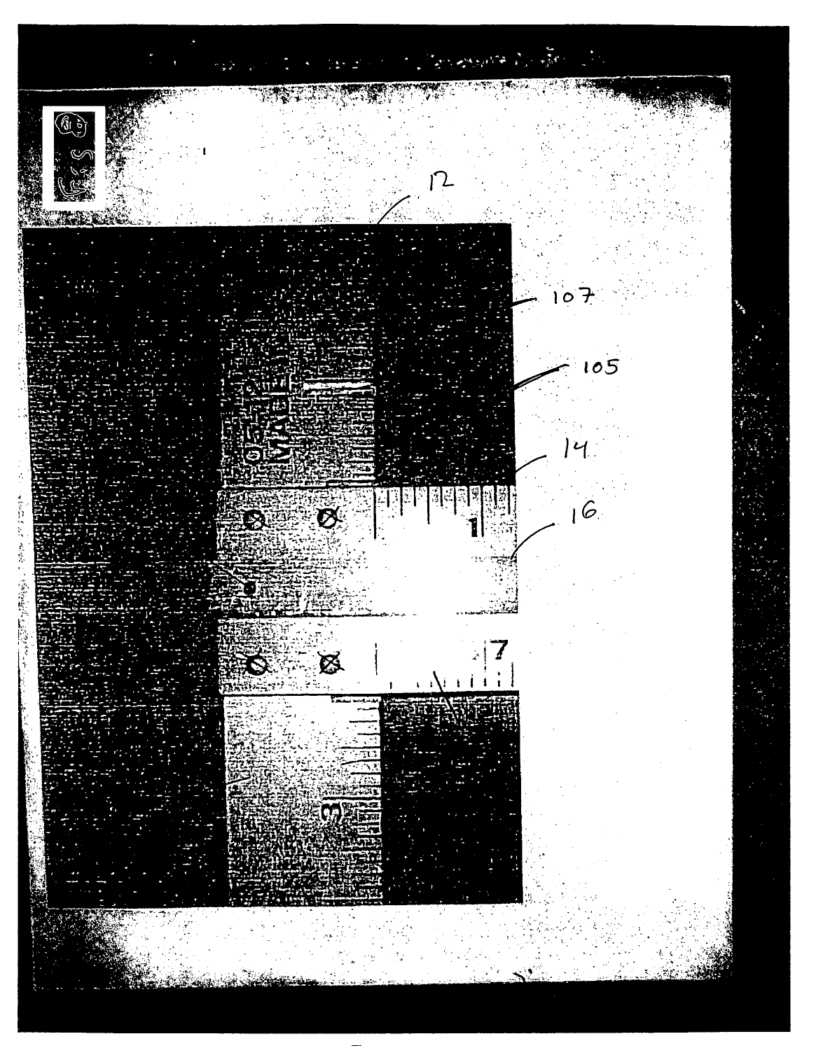

FIG. 9 is a side view of a blade holder guide pin of the body.

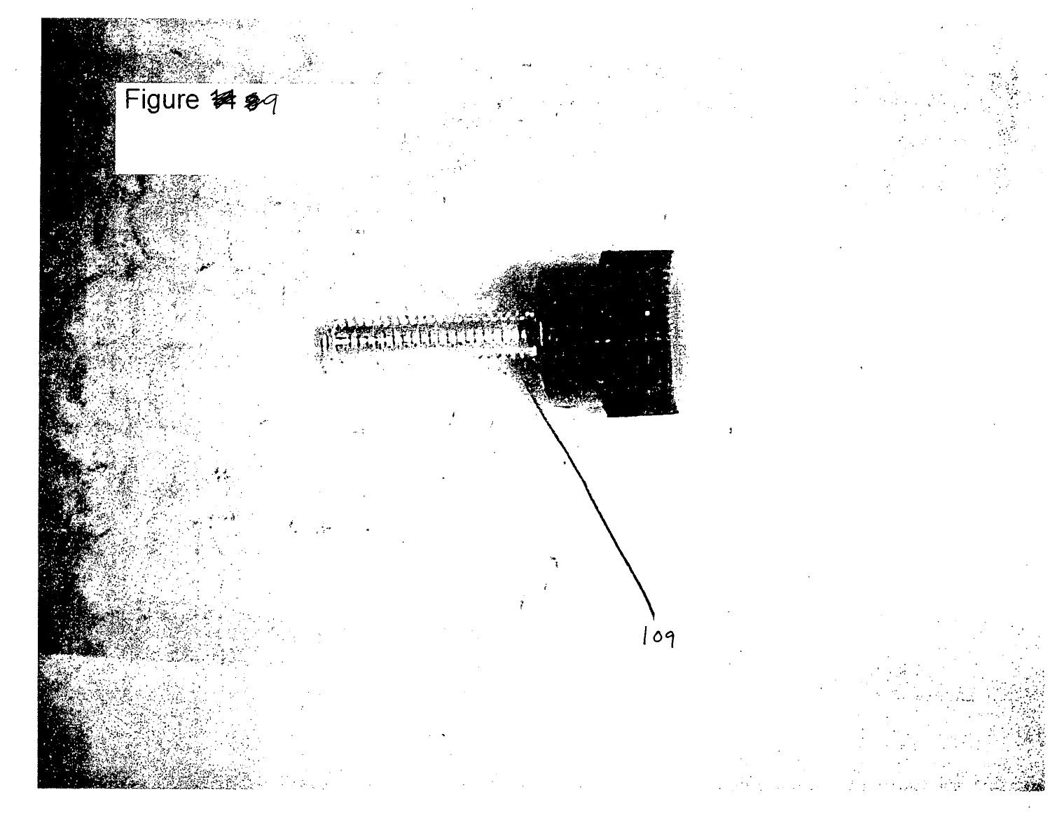

### DETAILED DESCRIPTION OF THE INVENTION

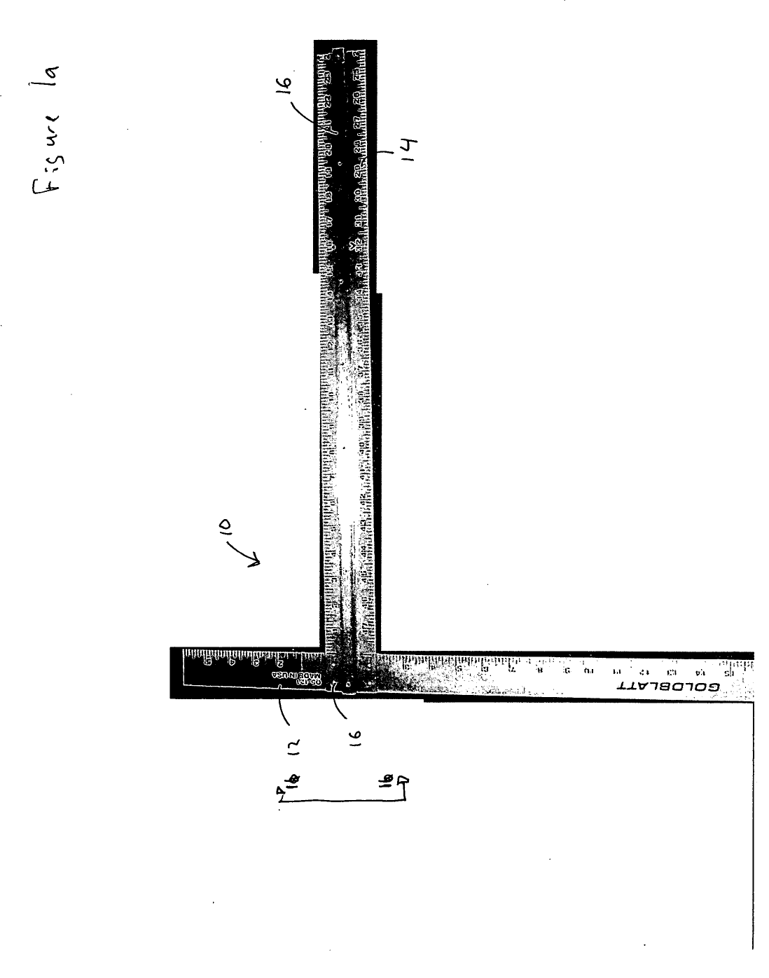

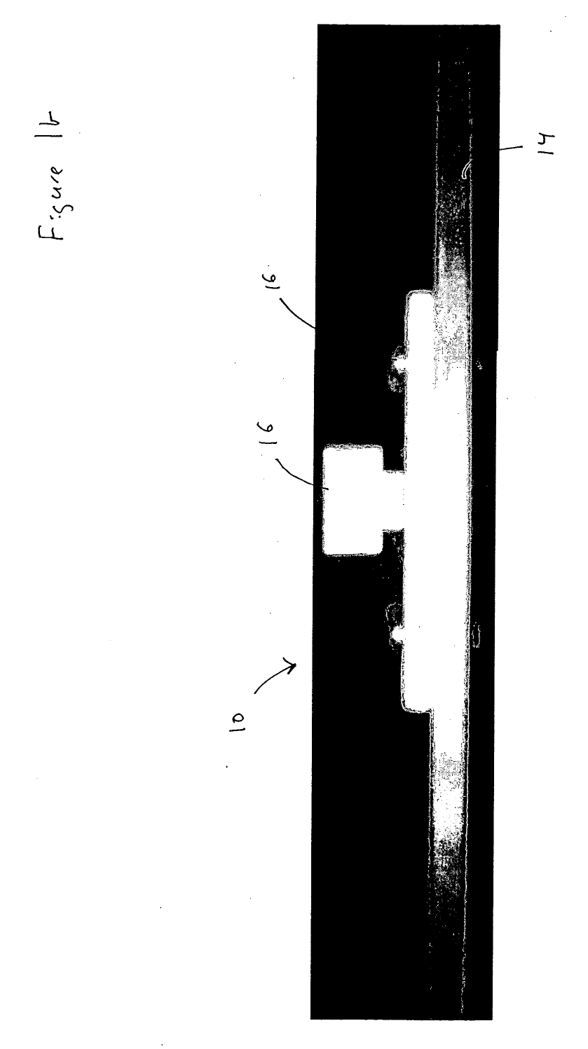

In the Figures, FIG. 1 shows a modified T-square 10 that includes a vertical bar 12 and a horizontal bar 14 in perpendicular orientation to each other, and rigidly affixed to each other with a plurality of fasteners 16. The orientation of the bars 12, 14 of the T-square 10 is arbitrary for purpose of this description, and actual use not limited to any specific orientation or position. Both the vertical and horizontal bars 12, 14, include ruler markings for general use in measuring and positioning of the T-square. A slide track 16 is mounted to the upper surface of the horizontal bar 14, and is rigidly attached along the longitudinal axis of the upper surface of the horizontal bar 14.

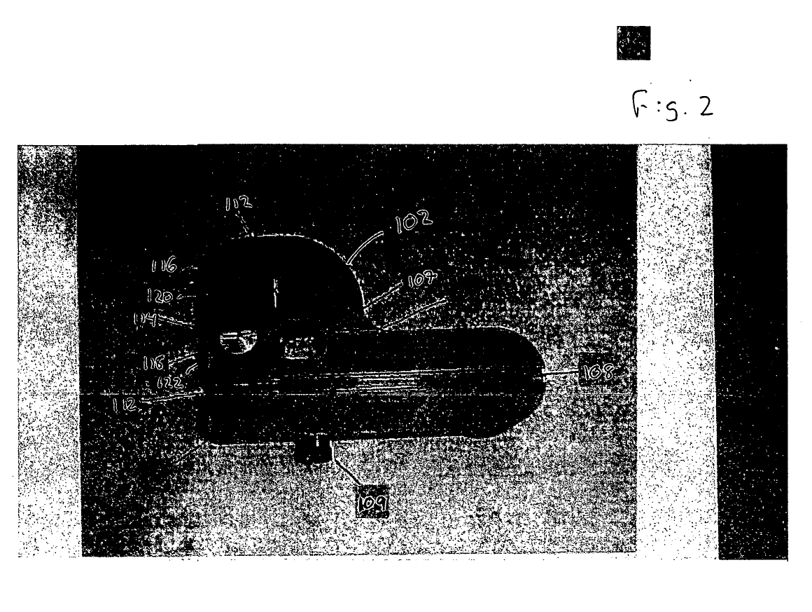

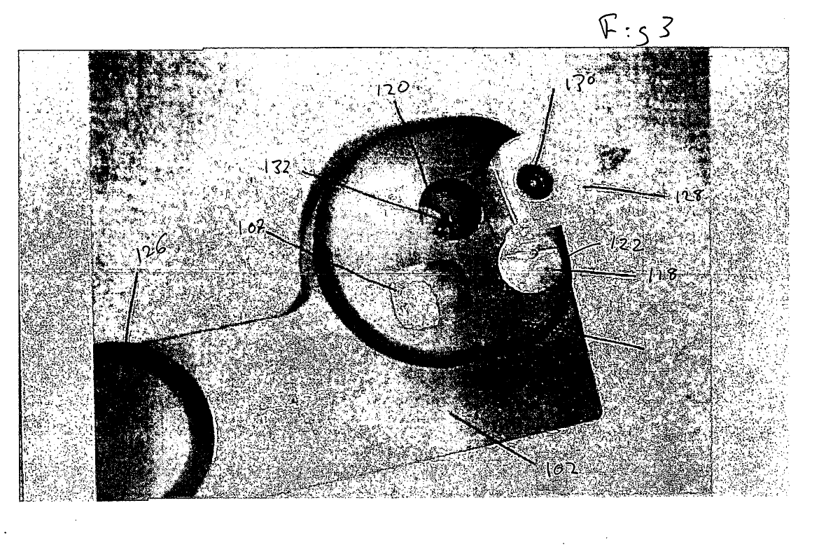

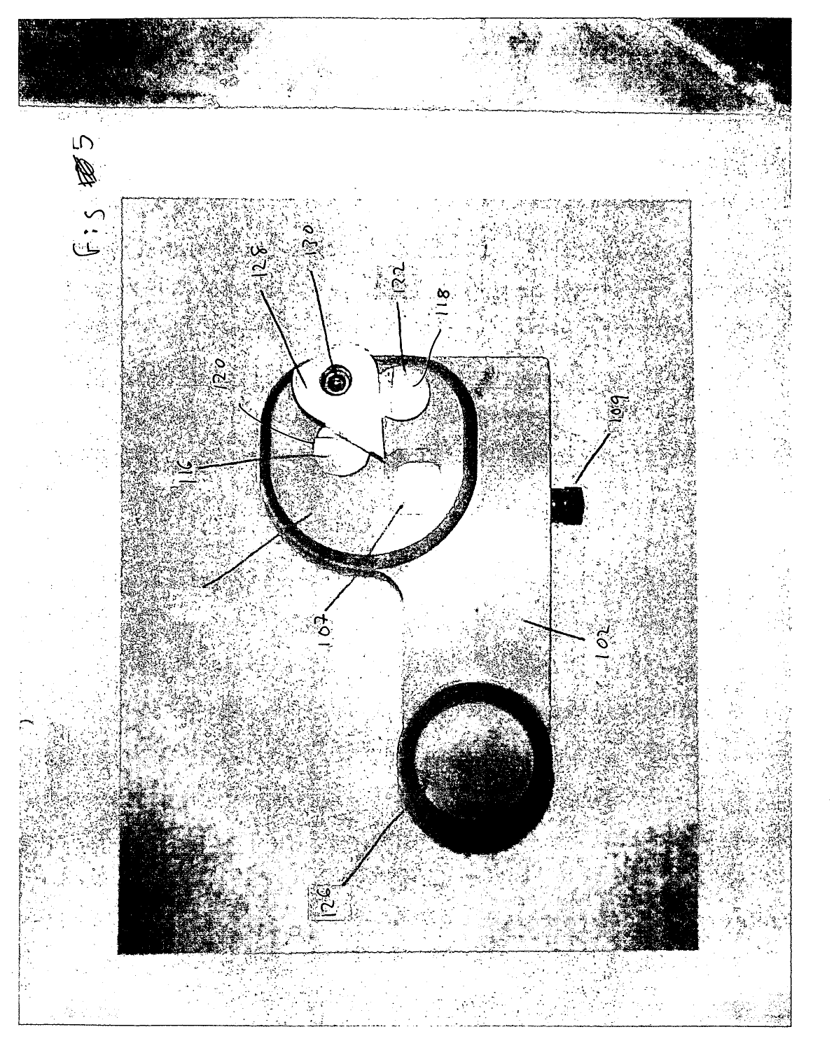

FIG. 2 shows the bottom of a body 102, which slideably engages with the slide track 16 of the T-square 10, to form the cutting device of the present invention. The body 102 includes a grove 108 on the underside that engages the slide track 16 mounted to the horizontal bar 14. Within the groove 108 is a positive stop groove 112, which catches on a vertical upper stop that can be located at the terminal end of the slide track 16, at the point where the vertical and horizontal bars 12, 14 intersect. This can prevent the body 102 from sliding off the horizontal bar 14. A locking thumb knob 109 threads into a hole 111 located on the side of the body 102. This allows for locking the body 102 against the slide track 16 at the desired position along the horizontal bar 14 to provide for vertical scoring or cutting. A viewfinder hole 107 passes through the body 102 to allow for viewing of the scale on the horizontal bar 14 to proper position the body 102 on the horizontal bar 14. A vertical cutting blade 112 and a horizontal cutting blade 114 protrude from the underside of the body 102. The blades 112, 114 are housed in vertical and horizontal blade holders 116, 118 respectively. The blade holders 116, 118 are releaseably housed in vertical and horizontal blade holder holes 120, 122 respectively (see FIGS. 3, 5).

The vertical bar 12 includes a horizontal relief slot 105 and a vertical relief slot 107, to allow the horizontal and vertical cutting blades 112, 114 to pass to the very edge of the vertical bar 106 without actually striking the bar 12.

A T-square relief 124 is located on the underside of the body 102. The relief 124 defines a boundary between the portion of the underside of the body 102 that is located on top of the horizontal bar 14 and the portion that overhangs the edge of the horizontal bar 14. The vertical and horizontal blades 112, 114 are located on or near the relief 124. The ⅛″ relief 124 allows the blades to sit flush along the lower edge of the horizontal bar 14, which is also preferably ⅛″ thick. The relief 124 also fits along the edge of the horizontal bar 14 to allow the body 102 to move true along the bar 14.

As can be seen in FIG. 2, the vertical blade holder hole 120 is located entirely on the relief 124. Thus, the hole 120 does not pass all the way through the body 102. The relief section forms a lower boundary for the hole 120, with only a small blade opening 123 extending all the way through the body 120, which prevents the vertical blade holder 116 from passing all the way through the body 102 while still allowing the vertical blade 112 to pass through the blade opening 123 in the relief 124 to contact the cutting surface. The horizontal blade holder 118, however, evenly straddles the relief section. Thus, the relief 124 forms a partial boundary such that the hole 118 is open all the way through the body 102 only on the portion that is not located on the relief 124 of the body, which is sufficient to prevent the horizontal blade holder 118 from passing through the body 102 while still allowing the horizontal blade 114 to contact the cutting surface.

FIG. 3 shows a top perspective view of the body 102. The body 102 further includes a body handle 126 that fits into the palm of the hand of a user to allow for easy movement of the body 102. A selector switch 128 is located on the top of the body 102. The switch 128 is attached to the body 102 with a bolt 130. The switch 128 moves between a neutral position wherein both of the blades 112, 114 are in a retracted position preventing engagement of the blades 112, 114 with the cutting surface. The switch 128 also moves to a position deploying the horizontal blade 114 while leaving the vertical blade 114 retracted, and a position deploying the vertical blade 112 while leaving the horizontal blade 114 retracted. In FIG. 3, the horizontal blade holder 118 is positioned in the horizontal blade holder hole 122, and the switch is in a position to deploy the horizontal blade 114 and leave the vertical blade 112 retracted (provided, however that in FIG. 3 the vertical blade holder 116 is removed from the vertical blade holder hole 120, which allows viewing of a vertical blade holder guide pin 132—an identical pin in the horizontal blade holder hole 122, as well).

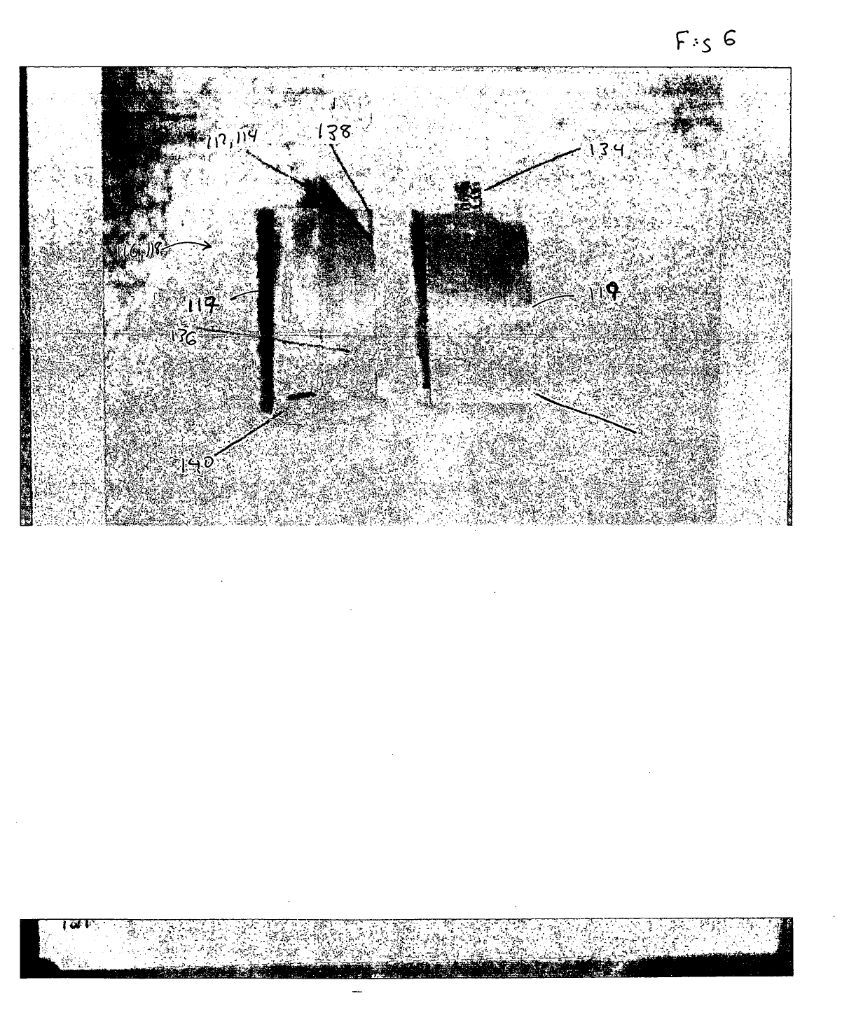

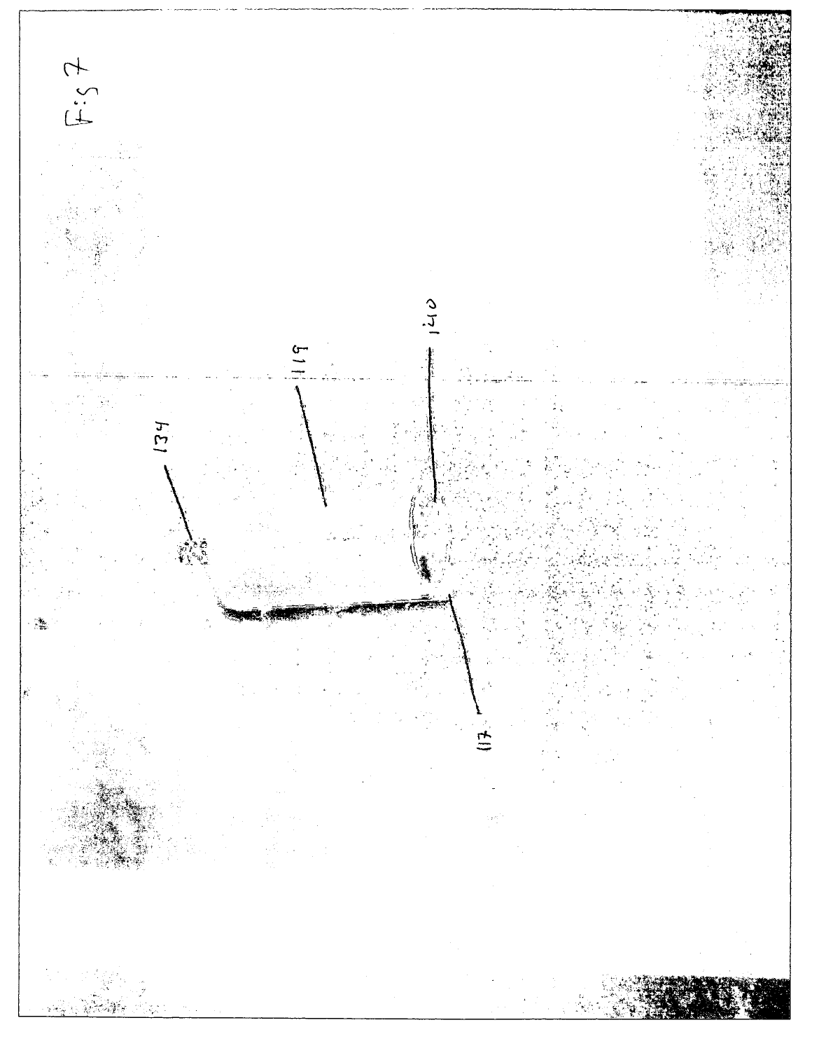

The blade holder guide pins 132 receive one end of extension springs 134, located on the ends of both the vertical and horizontal blade holders 116, 118 (see FIGS. 6, 7). The springs 134 bias the blade holders 116, 118 into the neutral position where the cutting blades 112, 114 are retracted. Each of the blade holders 116, 118 are further comprised of a first and a second blade holder sections 117, 119 (shown separately in FIG. 6, and together in FIG. 7). The blade sections 117, 119 releaseably capture a blade body 136 therebetween. Blade section 117 includes a boss 136 to retain the blade body 134. Otherwise, the blade body 134 seats within a channel 138 located in blade section 117.

Blade sections 117, 119 fit together to form a notch 140 (see FIG. 7) that allows the blade holders 116, 118 to bias to the retracted position when the selector switch 128 is in the retracted position (FIG. 5). Rotating the selector switch 128 clockwise, or counter clockwise, from the position shown in FIG. 3 will compress the respective blade holder 116, 118 against the extension spring 134 thereby extending the respective blades 112, 114.

In operation the modified T-square 10 with the body 102 mounted thereto can be used to make cuts in a vertical or horizontal direction. To make a vertical cut, the edge abutting surface of the vertical bar 12 is placed along the vertical edge drywall sheet, or cutting surface. The body 102 is positioned along the horizontal bar 14 the desired distance, using the viewfinder hole 107 to view the measuring scale. The locking thumb 109 is tightened to hold the body 102 on position. The selector switch 128 is rotated from the neutral position where the cutting blades 112, 114 are retracted, to the vertical cutting position to extend the vertical cutting blade 112. The T-square 10 is then slide along the edge of the drywall to extend the cut vertically up/down the cutting surface. The selector switch 128 is then returned to the neutral position.

To make a horizontal cut, the edge abutting surface of the vertical bar 12 of the T-square 10 is positioned along the vertical edge of the drywall, or cutting surface. The measurement scale on the vertical bar 12 is used to correctly position the T-square 10. The body 102 is at the abutting end of the cutting surface. The selector switch 128 is rotated form the neutral position where the cutting blades 112, 114 are retracted, to the horizontal cutting position to extend the horizontal cutting blade 114. The body 102 is then slide along the edge horizontal bar 14 to cut vertically across the cutting surface. The selector switch 128 is then returned to the neutral position.

The present invention offers a new solution by utilizing completely retractable blades. The blades are held within the blade housing of the block portion until the device is in position to score. A blade selection knob allows the user to extend the blades for scoring, and then retract the blades into a protective housing, thereby preserving the blades and protecting the user. Furthermore, the blades are covered and surrounded by the sliding block portion during use, making it virtually impossible for the user to come in contact with the blade. Additionally, the elevated block portion allows the user to keep their fingers raised up and away from the material being cut, eliminating the painful friction that is often associated with using utility knifes or other cutting devices.

Furthermore, there are two blades in the device, situated for cutting in multiple directions. The blade selector knob allows for the user to switch the device for cutting in the horizontal or vertical directions, with minimal repositioning of the entire device, and includes a neutral safety position with both blades retracted. This device allows the user to switch from the horizontal to the vertical cutting direction with merely a switch of the blade selector knob. Additionally, if one edge of the drywall is jagged or uneven, the user can use a perpendicular edge as a guide, and still achieve a straight cut. The device allows for the horizontal and vertical cuts to be made perpendicular to each other, rather than to the edges of the drywall, thereby creating square comers in the cut portion, even when they were not square with respect to the actual drywall portion.

Operation of the device is simple enough that drywall cutting can be used with little if any training by anyone with basic skill in the art.

Although the invention has been described with respect to a preferred embodiment thereof, it is to be understood that it is not to be so limited since changes and modifications can be made therein which are within the full intended scope of this invention as defined by the appended claims.

1. A cutting device, comprising:
a T-square;
a body slideably mounted thereto;
a cutting blade housed within said body; and
a selector switch for selectively extending and retracting said cutting blade.

2. The device in accordance with claim 2 wherein said cutting blade is a first cutting blade and further comprising a second cutting blade, wherein said cutting blades are substantially perpendicular to each other.

3. The device in accordance with claim 2 wherein said selector switch moves between a first position where both cutting blades are retracted, a second position where one cutting blade is retracted and the other is extended, and a third position in opposition said second position.

4. The device in accordance with claim 1 further comprising a viewfinder for viewing a measurement scale along an axis of said T-square.

5. The device in accordance with claim 1 wherein said body further comprises an alignment groove, and said T-square further comprises an alignment rail for slideable engagement with said alignment groove.

6. The device in accordance with claim 5 wherein said body further comprises a stop groove capable of preventing said body from disengaging said alignment rail by abutting a stop located on said T-square.

7. The device in accordance with claim 1 wherein said body further comprises a blade housing for retaining said cutting blade.

8. The device in accordance with claim 7 wherein said body further comprises a hole for engagement of said blade housing.

9. The device in accordance with claim 7 wherein said blade housing further comprises a spring for biasing said cutting blade and said blade housing into said retracted position.

10. The device in accordance with claim 7 wherein said blade housing further comprises two sections where said cutting blade is retained therebetween.

11. The device in accordance with claim 1 wherein said body further comprises a first and a second hole for engagement of a first and a second blade housing, wherein said blade housings are each further comprised of two sections for retaining a first and a second cutting blades therebetween, and wherein said blade housings are biased by springs into said retracted position.

12. The device in accordance with claim 1 wherein said body further comprising a lower surface divided into a first portion and a second lower portion such that said lower portion is coplanar with the bottom of said T-square.

13. The device in accordance with claim 1 further comprising a locking thumb knob for securing said body to said T-square.

14. The device in accordance with claim 1 further comprising a form fitted handle.
